(19) United States
(12) Patent Application Publication
(10) Pub. No.: US 2006/0245389 A1
(43) Pub. Date: Nov. 2, 2006

(54) Wireless communication system using mobile devices or repeaters

(76) Inventor: Paul Edwards, Woodside, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/395,642

(22) Filed: Mar. 31, 2006

Related U.S. Application Data
(60) Provisional application No. 60/667,436, filed on Mar. 31, 2005.

(51) Int. Cl. H04Q 7/00

(52) U.S. Cl. 370/328

(57) ABSTRACT

A wireless communication system using mobile devices or repeaters are described. In one embodiment, a communication system comprises a base station and a plurality of terminal devices, wherein at least one of the terminal devices operates, at least a part of the time, as a repeater.

### PRIORITY

The present patent application claims priority to the corresponding provisional patent application Ser. No. 60/667,436, entitled, “Wireless Communication System Using Mobile Devices or Repeaters,” filed on Mar. 31, 2005.

### FIELD OF THE INVENTION

This invention relates to wireless communication; more particularly, this invention is related to using terminal devices as repeaters to form a more complete wireless network. This method could be extended to wired communication in areas where there are physical limitations to endpoint spacing.

### BACKGROUND OF THE INVENTION

The most popular form of wireless network is the Cellular Radio Network where there is a base station at the center of every “radio cell”, and the “radio cells” are contiguous to completely cover an area. The popular form of wired network is the Store-and-Forward network (e.g., The World Wide Web—the Internet—is a store and forward network).

A cellular network is a star network; it has a control unit—a base station—at the center of each network cell. A Store-and-Forward network is fundamentally a peer-to-peer network with no central coordinating unit. That is, the Internet has name servers, but these are not coordinating units in the sense here.

### SUMMARY OF THE INVENTION

A wireless communication system using mobile devices or repeaters are described. In one embodiment, a communication system comprises a base station and a plurality of terminal devices, wherein at least one of the terminal devices operates, at least a part of the time, as a repeater.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates one embodiment of a fixed point cellular radio network;

FIG. 2 illustrates one embodiment of a fixed point store and forward cellular radio network; and

FIG. 3 illustrates one embodiment of an extended star topography.

### DETAILED DESCRIPTION OF THE PRESENT INVENTION

A method and apparatus is disclosed herein for communication system using terminal devices as repeaters and method for using the same.

In one embodiment, each endpoint in a cellular network can act as a repeater to create an extended cell—an enhanced network. This means that an endpoint need not actually be in range of a base station, but simply be in range of another endpoint that is in the range of the base station, or recursively in range of an endpoint that is, in turn, in range of an endpoint that is in touch with the base station. This recursion can practically go on for many store and forward “hops”.

A network of this type can be easily be used in a “fixed point” cellular radio application. Common applications of this type include meter reading networks for electric, gas, or water utility companies.

A network of this type can also be used for mobile cellular radio networks. The routing algorithm becomes more dynamic for a mobile application though. The more dynamic nature of the function could be achieved simply by running the routing algorithms more frequently.

The 802.11 protocol described herein is a PHY and MAC layer data communication protocol, but it can easily be expanded to include voice, and other analog applications as well. There is VoIP already running over 802.11, and also many more audio applications that do not include IP. Also, 802.11 is called out here as a good example, but is not the only vehicle for achieving a network of this sort.

In one embodiment, some functions that have been traditionally performed above the data link layer (OSI 7 layer model) are moved into the data link layer. The 802.11 protocol already does this with such things as fragmentation and security. Routing, balancing and other topology functions can also be moved down into layer-two.

One new technology that makes this method particularly attractive is the 802.11 standard for high speed RF data communication.

### DEFINITION OF TERMS

Unit Addressed—Addressed to a specific endpoint, not broadcast or multicast
RSSI—Received Signal Strength Indication
802.11—A PHY and MAC Layer IEEE specification for RF networks
Inbound—Traffic going from an Endpoint to the network Hub
Outbound—Traffic going from the network Hub to an Endpoint
RF—Radio Frequency
Cell—Cellular Area, an area covered by a Hub or Base Station
WAN—Wide Area Network, could be the entire Internet
LAN—Local Area Network, could be one Cell
VoIP—Voice over Internet Protocol
IP—Internet Protocol (in other circumstances can also mean Intellectual Property)
Star Network—A network where all network traffic goes to/from a Hub. 10-base-T is a star network, 10-base-2 is not.
PHY—Physical layer. Layer-1 of the 7-layer model
MAC—Media Access Control. Part of layer-2 of the 7-layer model
Hub—Base station
Base Station—Hub
AP—Access Point
Station—Endpoint
PSR—Packet Success Rate
FEC—Forward Error Correction

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

Extended Star Topology

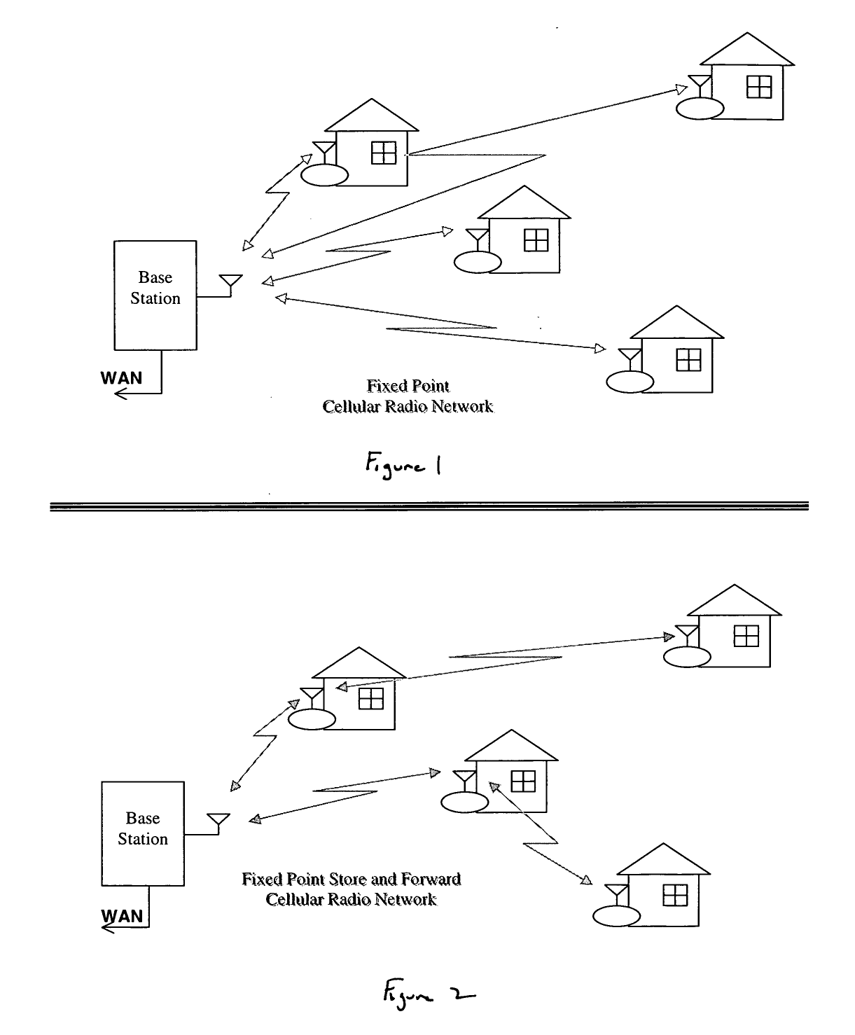

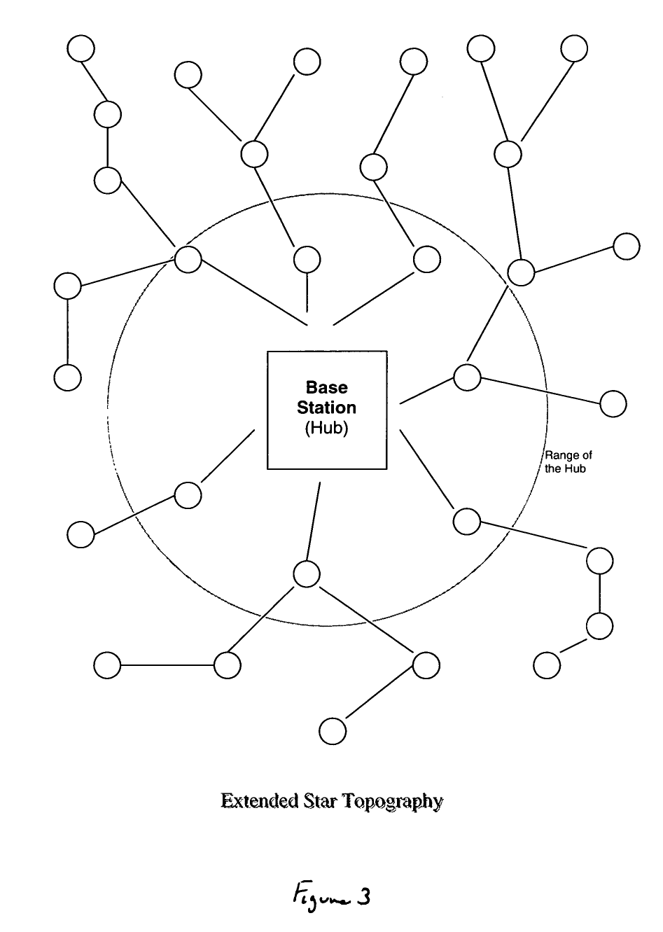

FIG. 1 illustrates one embodiment of a fixed point cellular radio network. FIG. 2 illustrates one embodiment of a fixed point store and forward cellular radio network. In one embodiment, the present invention combines the two network philosophies of the Star network and the Store-and-Forward network to reduce the number of base stations required in a cellular network, and also reduce the necessary transmit power and receive sensitivity of each cellular endpoint.

In one embodiment of the system, the network balancing and routing is done by a distributed system, while the bookkeeping and statistics of the system are kept in a central location. The system is dynamic and expandable while being controlled and maintainable.

This network can be considered an Extended Star Topology. FIG. 3 illustrates an example of the Extended Star Topology. All traffic will go to (inbound) and from (outbound) the central Hub of the star, but not necessarily be directly addressed to (or from) the central Hub. If the transmission environment puts the Hub out of range of an endpoint, the endpoint will instead send its traffic to a closer endpoint that can in turn send that traffic (perhaps recursively through more endpoints) onto the Hub.

In one embodiment, each endpoint in this network can act as a repeater to extend the network.

Sub-Net Routing

LAN or Sub-Net routing is a new concept. Normally routing is reserved for the greater network, and not for the relatively simple local network. Endpoints on local networks traditionally have no need for routing, as they simply broadcast packets and let other entities (routers, gateways) handle any necessary routing. In an extended star network, each element has some rudimentary knowledge of routing—each element knows the best address to send a packet to reach the Hub. Each element receiving inbound traffic is able to forward that traffic along to this best address.

This form of simple routing can be done at layer-two of the 7-layer model. It can be—and has traditionally been—done at a higher layer if desired.

Network Balancing

Network balancing and best route calculation is done by the endpoints in a distributed manner. In one embodiment, the endpoints establish routing and balancing by broadcasting a special Route Probe message when they enter the network, and all endpoints in the vicinity that receive the Route Probe responds with a Route Status message. In one embodiment, the Route Status message contains the following information (as an example).

| | |
|---|---|
| UINT32 JumpsToBaseStation | /* number of hops to get to Hub */ |
| UINT32 RouteEndpointsSupported | /* number of endpoints using this |
| | route */ |
| UINT32 TotalEndpointsSupported | /* endpoints on this frequency on |
| | this Hub */ |
| UINT32 InboundWeakRSSI | /* RSSI of weakest In hop to Hub */ |
| UINT32 OutboundWeakRSSI | /* RSSI of weakest Out hop to |
| | Hub */ |
| UINT32 ProbeRSSI | /* RSSI of the received Route |
| | Probe */ |

The endpoint entering the network collects all Route Status responses and use the information contained within to choose the best address to send packets to in order to get to the Hub. The Endpoint chooses this address (this route) based on a heuristic that reduces, and potentially minimizes, the JumpsToBaseStation and EndpointsSupported while increasing, (e.g., maximizing) the different RSSI readings (there will be another RSSI reading available—the RSSI of the Route Status message received).

A Hub also responds to a Route Probe, and has a JumpsToBaseStation value of zero. The ProbeRSSI and InboundWeakRSSI are equal for a response from the base station. A base station has an OutboundWeakRSSI of 0 as the RSSI of the only outbound hop is measured by the endpoint receiving the Route Status message.

After choosing the best route (address) to the Hub for itself by examining the Route Status responses received, an endpoint creates/updates its own Route Status message to use in response to any Route Probe message it may receive. This new Route Status message will be based on the Route Status response of the inbound route chosen by the Endpoint. The Endpoint's Route Status message increments the JumpsToBaseStation by one. The Endpoint's Route Status message increments EndpointsSupported value by one (more than one if this endpoint is recursively supporting endpoints). The Endpoint's Route Status message decreases the OutboundWeakRSSI if the RSSI of the chosen Route Status response is lower. The Endpoint's Route Status message decreases the InboundWeakRSSI if the ProbeRSSI in the chosen Route Status message is lower. In one embodiment, aspects (e.g. EndpointsSupported) of each endpoint's Route Status message will be periodically updated by the Hub in Route Update messages unit-addressed to the endpoint.

There are values besides RSSI can be used to determine the best or most favored transmit link. These include, for example, PSR and FEC performed, among others.

In one embodiment, the only thing an Endpoint needs to know/remember about the inbound route is the first address on the route it has chosen.

Route Header

In one embodiment, all inbound and outbound traffic in this network that goes over more than one hop (is not directly addressed to/from the Hub) has a Route Header in it. The Route Header goes after any existing packet header. The packet header will have an indication (e.g., a pattern in the body of the message) in it to signal that there is a Route Header present. This indication could be special address(es) or perhaps specific pattern(s) in packet header field(s).

Routing Tables

Up-to-the-moment routing information will be kept at a central location—the LAN Hub. The Endpoint needs to know the single address to which to send inbound traffic. The Hub keeps a routing table based on the latest traffic inbound from each endpoint. All inbound traffic contains the addresses of all endpoints on the inbound route, and the Base Station pre-pends this route map to all outbound traffic (in the Route Header).

The base station periodically updates each endpoint it is responsible for with information on the overall network, and on the portion of the network pertinent to the endpoint. In one embodiment, this information comes in the form of a unit addressed Route Update message from the base station.

The Hubs can, if need be, communicate with each other (over the WAN backbone) to keep track of the endpoints supported. Even a fixed point endpoint may move from one Hub to another depending on the transmission environment or the loads in each of the Hub's Cells.

Inbound Traffic

Traffic going in toward the Hub has an indication in the Route Header signaling that it is Inbound. When an endpoint receives an Inbound message, it pre-pends its own address onto the Route Header and forward the message along that Endpoint's pre-determined “best route”. When the inbound message reaches the Hub, the entire route for the originating endpoint will be contained in the Route Header, and the Hub can update its routing tables accordingly.

Outbound Traffic

Traffic going out from the Hub has an indication in the Route Header signaling that it is Outbound. The Hub creates a complete Route Header for outbound messages, and this header contains, in order, the address of all endpoints on the outbound route. The Hub moves the first address in the Route Header from the Route Header into the destination address for the packet.

Upon receiving an outbound message, an endpoint examines the Route Header. If the Route Header contains one or more addresses, the endpoint removes the first address from the Route Header and sets that address as the destination address for the packet before sending it on along its route. If there is no Route Header, or the Route Header does not contain any address, the endpoint assumes that the packet is for it, and process it accordingly.

802.11 Interaction

As previously stated, 802.11 may be-used but is not required. It is a well-known example of an existing low-level protocol that this method can employ.

Each endpoint of this network could-be its own 802.11 infrastructure LAN (acting as an AP), giving access to any 802.11 device within range of the endpoint, and using the network described here as the WAN access.

### AN EXAMPLE OF AN IMPLEMENTATION

This example uses 802.11 as a foundation for the implementation. As mentioned above, 802.11 is not required to implement the techniques described herein, but as it is a well understood layer-one-and-two data protocol, we will refer to it here. This is just an example of how techniques described herein could be implemented over 802.11, it is not the exclusive avenue to implementation.

Send Route Probe

A new endpoint comes into a network area. The new endpoint broadcasts a Route Probe message. The message header indicates that it is a routed message, and the Route Header indicates that it is a Route Probe. The endpoints (or Hubs) receiving this broadcast examine and respond to the Route Probe.

| | | |
|---|---|---|
| Preamble | 802.11 Header | Route Header |
| | ToDS and FromDS both set | Type Field = Probe |
| | Source Address = 1.2.3.4.5.6 | 1^{st} Address = |
| | | True Source Address |

Respond with Route Status

In one embodiment, all endpoints receiving the Route Probe broadcast responds with a unit-addressed Route Status message. In one embodiment, the Route Status message has pre-created by the station (unless received RSSI forces a lowering of the InboundWeakRSSI), and reflects the current routing status for the station.

| | | |
|---|---|---|
| Preamble | 802.11 Header | Route Header |
| | ToDS and FromDS both set | Type Field = Status |
| | Source Address = 1.2.3.4.5.6 | 1^{st} Address = |
| | | True Source Address |

Create and Update Route Status

With the information an endpoint gathers

Inbound Routed Traffic

| | | |
|---|---|---|
| Preamble | 802.11 Header | Route Header |
| | ToDS and FromDS both set | Type Field = Inbound |
| | Source Address = 1.2.3.4.5.6 | Pre-pend station's address |

Outbound Routed Traffic

| | | |
|---|---|---|
| Preamble | 802.11 Header | Route Header |
| | ToDS and FromDS both set | Type Field = Outbound |
| | Source Address = 1.2.3.4.5.6 | Peel and use first address |

Update Route 100491 In one embodiment, periodically an endpoint will re-broadcast the Route Probe message, and re-evaluate the best route to the Hub. An endpoint can always re-evaluate if the PSR to the Hub drops.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A communication system comprising:
a base station; and
a plurality of terminal devices, wherein at least one of the terminal devices operates, at least a part of the time, as a repeater.
